(19) United States
(12) Patent Application Publication
(10) Pub. No.: US 2024/0013267 A1
(43) Pub. Date: Jan. 11, 2024

(54) SYSTEM FOR THE FULLY AUTOMATED ACQUISITION OF TICKETS

(71) Applicants: Dirk Bohnes, Jupiter, FL (US); Jack Bohnes, Jupiter, FL (US)

(72) Inventors: Dirk Bohnes, Jupiter, FL (US); Jack Bohnes, Jupiter, FL (US)

(21) Appl. No.: 18/336,373

(22) Filed: Jun. 16, 2023

Related U.S. Application Data
(60) Provisional application No. 63/367,824, filed on Jul. 7, 2022.

(51) Int. Cl. G06Q 30/0283; H04W 76/10; G06Q 50/30

(52) U.S. Cl. CPC G06Q 30/0283; H04W 76/10; G06Q 50/30

(57) ABSTRACT

A system for the automated acquisition of tickets, including a first device (client) with a radio module for wireless data transmission. Also including a vendor for wireless data transmission which is suitable for exchanging data with the client. In the event of an initialized connection, the authentication between the client's device and vendor's device is started. Following a successful authentication, the client's device is designed to transmit client related data. The client related data are then verified, and a unique ticket is generated in the event, that predefined criterions are satisfied. The issued ticket provides access to the client requested services. The method according to the invention allows for maximum convenience, and reliability in issuing tickets for travelling with transportation systems or attending an event and/or granting physical access to a service or location.

### SUMMARY OF THE INVENTION

It is an object of the present disclosure to provide a system for the transmission of client data, in particular for establishing contact between two or more unknown to each other devices, offering a fully automated ticket acquisition, checking-in the client via a mobile device of the client, with or without the need of an internet connection upon accessing a vehicle of the transport system, accessing an event or an access gate; fully automated checking-out the client via the mobile device or a wearable device upon exiting a vehicle of the transport system or leaving an event, with or without the need of an internet connection. The ticketing method particularly further comprises: a connection of the client mobile device with the vendors device to determine and confirm the status of the client.

Relating to our invention, a “mobile device” can be either a smart phone, a smart watch or personal electronic wearable, carried by the client during their travels or during attending of an event, which initiates a computer program to begin the specified ticketing method.

Relating to our invention, a “vendor” can be either a tablet, a smart phone or a Processing Unit including wireless connectivity features (one or multiple radio modules), e.g., Bluetooth, WiFi, Narrow Band, UWB, etc., which initiate a computer program to process the specified ticketing method.

The term “vehicle” can refer to the specific apparatus which is suitable for transporting human or animal, either singular or plural, for travel or is carried; various means of conveyance for transport exist: a motor vehicle; water vehicle, air vehicles, snow vehicle, a conveyance moving on wheels, runners, tracks, wings, or the like, as a cart, sled, automobile, helicopter or airplane or the like.

This object is achieved by a system according to claim 1 as well as a method for operating the system according to claim 14.

The system for the transmission of client data according to the disclosure includes a first device having a first radio module for wireless data transmission. Furthermore, the system includes at least one second device having a second radio module for wireless data transmission, where the second radio module is suitable for exchanging data with the first device. Here, the first radio module and/or the second radio module are configured for sending an initialization which is received by the other radio module for initializing a wireless radio connection between the first device and the second device. Thus, an initialization by the first radio module, an initialization by the second radio module or a common initialization by both the first radio module and the second radio module can be performed. In particular, the initialization is realized as a handshake for transmitting the relevant data transmission parameters between the first device and the second device. A successful initialization and authentication between the client's device and vendor device, includes general information of the client and vendor between whom a contact is to be established, for example the information “I am able to issue/sell a ticket”, “I want to buy a ticket”. Also, the initialization can contain information of whether at the present time sales information or information on the respective interests is to be sent to the client of the first device and/or the second device. However, it is also possible that the initialization already contains personal data which are provided in an encrypted manner. The decryption can only be performed by devices of the system using a common key or other known encryption algorithms. In particular, a private key exists on the first device, a common public key and a private key exist on the second device, where encryption is performed on the first device by means of the private key of the first device and the public key, and encryption is possible only when the private key of the second device is known.

According to the disclosure, in the case of an initialized connection, the first device is configured such that the first radio module directly sends the personal data to the radio module of the second device. The second radio module is particularly configured for receiving the personal data from the radio module of the first device. If personal data are transmitted from the first device to the second device, the personal data is processed on the second device, where a ticket is generated when predefined criteria is satisfied. Here, the criteria can be a purchase price or the restriction with regards to an object of purchase, for example: The client may wish to obtain information on a certain subject, advertisements, offers or the like. Due to the direct transmission of the personal data between the first device and the second device it is no longer required to exchange personal information worthy of protection with a server via the internet, whereby an undesired disclosure of the personal data is reduced. Thereby, the risk of the personal data being unintentionally or intentionally used by an operator of the server is reduced. Since a direct transmission between the devices of the system is performed, a system is created which is dislocated to a smaller extent than in the case of server-based applications for issuing tickets for public transportation and/or events.

Alternatively, the client data refers to the position of the client. Here, first an initialization between the first device and the second device is performed. Then data are exchanged in predefined time intervals. For example, the first device is carried by the client. The second device is installed at a fixed defined position, like a vehicle, train station gate or venue. The criteria is the establishing or loss of connection between the first device and the second device. If after elapse of the predefined time interval no data are exchanged between the first device and the second device, the criterion is satisfied, and an indication or action is generated. For example, where the second device is arranged in a bus and the client leaves the predefined area so that data is no longer exchanged between the first device and the second device, an action or indication is triggered, where a check-out of the trip is initiated.

Preferably, the client's device generates an encrypted key based on the client's data. The vendors device generates an encrypted key based on the vendor's data. Thus, a comparison of the client's and vendor's data can be performed based on thus generated keys, where a communication of the client and the vendor is only possible when a decryption by means of the keys is possible. The criteria to be satisfied is thus the ability to decrypt the transmitted data by means of the private key of the second device.

Preferably, when the connection is initialized, vender specific data are also directly sent by the second device radio module to at least one first devices radio module. Then a comparison of the exchanged data is also performed on the first device, and only when predefined criteria of both the first and the at least one second device is satisfied, the processing of the transaction is continued. If a plurality of second devices is provided, a comparison of the exchanged data is in particular performed on each of these second devices. Thus, a comparison of the exchanged data is performed on both and/or all devices such that on both and/or all devices the information is available as to whether there is an adequate agreement such that, accordingly, the processing of the transaction is continued. Thus, no server-based data transmission is necessary which would require an access point to a wireless communication network. Thus, a simple infrastructure is created.

Refers to entering a vehicle by either walking into, sitting on, or stepping into or the likes of.

Preferably, a third device is provided which is in particular of a stationary configuration or is arranged stationarily. In particular, the third device serves as a host, where the third device includes a third radio module for wireless data transmission, where the third radio module is suitable and configured for exchanging data with the second and/or the first device. Here, the first radio module is configured for sending an initialization which is received by the third radio module and forwarded to the second radio module of the second device for initializing a wireless radio connection between the first device and the second device. Furthermore, an initialization can be sent from the second radio module of the second device, as described above, and be forwarded to the first device via the third device. Thus, an initialization by the first radio module, an initialization by the second radio module or a common initialization by both the first radio module and the second radio module can be performed, where always the wireless communication link between the first device and the second device is realized via the third device serving as a host.

Preferably, in the case of a suitable initialization of the wireless radio connection, all of the first and/or the second devices are adapted to be connected to each other by means of the third device serving as a host.

Preferably, the third device does not have any internet connection, no wireless telecommunication connection (such as GSM, 3G, 4G, 5G or the like) or any connectivity beyond the third radio module such that the first device and/or the second device together with the third device defining a closed network for exchanging personal data. Thereby, the data security is increased.

Preferably, more than one second device is provided, where the initialization is received and/or sent by all second devices. In particular, in the case of an initialized connection between the first device and the plurality of second devices, a direct transmission of the exchanged data is then performed, in particular via the third device. Here, the first device and/or each of the second devices are configured for performing a comparison of the exchanged data and generating an indication when predefined criteria is satisfied. If more than one device satisfies the criteria, an automatic or manual selection of that device can be performed that is designed to generate the indication. It is particularly preferred that a second device can be selected that best satisfies the criteria, for example when many transportation types and/or possibilities (e.g. bus, train or subway) exist.

Preferably, the personal data are not transferred to the second device via a base station of a mobile radio communication system, for example eNB (Evolved Node B), a server or a core net (EPC-Evolved Packed Core) of a mobile radio communication system. Alternatively, or additionally, the transfer of personal data does not take place via an access point of an Internet architecture (for example but not limited to WLAN, WAN, 5G). Here, forwarding of client's data exclusively takes place in a point-to-point connection between the first device and the second device so that no other portion of the data transmission infrastructure has access to the client's data. This provides the advantage that no radio connection to any external infrastructure is required and thus the system can also be used in enclosed rooms or the alike. Alternatively, in particular when a third device is provided, an initialization can be realized via the third device and then a data exchange between the first device and one of the second devices is performed through a point-to-point connection or also via the third device serving as a host.

Preferably, the wireless data transmission is effected via an NFC connection (Near Field Communication), a Bluetooth connection in particular of the fifth generation, a ZigBee connection, an ultra-wide band connection (UWB-Ultra-WideBand) or a CSS connection (Chirp Spread Spectrum). Generally, the wireless data transmission is a wireless data transmission via WPAN (Wireless Personal Area Network).

Preferably, the first device sends the initialization via Broadcast. Thus, the initialization can be received by a plurality of further devices, where merely such connections are initialized where a direct wireless data transmission can be performed. For example, the initialization is a Bluetooth initialization which is sent via Broadcast. The Bluetooth connection of the first device can however only be realized with a second device which is also configured in accordance with the present system. Furthermore, a connection as described above is in particular realized only when the preconditions possibly contained in the initialization are met.

Preferably, the first device includes a positioning module for determining the position of the first device. Alternatively, or additionally, the second device includes a positioning module for determining the position of the second device, where the first device and/or the second device are configured for exchanging their respective position either directly or over a common server. This is in particular effected by means of a respective further radio module. Here, the initialization between the first device and the second device is performed only when they are located at a predefined distance to each other. In particular, this distance is smaller than 100 meters and preferably smaller than 30 meters. Thus, although the position of the first device and/or the second device can be transmitted to a common server, the exchange of client's data continues to be performed between the devices so that no client's data, except for the respective position, are transferred to the server. Thereby, it is no longer required to send the initialization via Broadcast, but the initialization can be specifically sent and addressed to the second device which is located at the predefined distance.

Preferably, the first device and/or the second device are a mobile terminal, for example a mobile phone, a laptop, a tablet, a smartphone, a wearable, for instance a smartwatch, a smart wristband, and the like. However, preferably the first device and or the second device are a separate beacon whose function is limited to the functionality of the system described above. In particular when the first and/or the second device are configured as a beacon, they exclusively include a single radio module for direct transmission of personal data to the respective other device.

Preferably, the indicating element is configured as a separate indicating element which is separated from the first device and/or the second device. For example, if the first device is a terminal, the indicating element configured as a separate indicating device can be a normal flashing light which is connected in the usual manner to the terminal via Bluetooth. If a ticket is generated, the terminal sends a corresponding signal to the separate indicating device which then can generate the indication as a haptic and/or optical and/or acoustical indication.

Preferably, the first and/or at least one second device includes a processor at least for performing the comparison and processing of the client's data. Here, the radio module and/or memory module can be connected to the processor. Further functions can also be provided by the processor.

Furthermore, the present invention relates to a method for operating a system described above.

Furthermore, the invention relates to a device having a processor and a memory, where a program is stored in the memory and can be executed on the processor for performing the method for operating the device described above, in particular the initialization of a connection to at least one further device, exchange of personal data, comparison and processing of the client's data and check for criteria satisfaction and generation of an action when the criteria is satisfied. Furthermore, the device can be further developed in accordance with the features of the system described above.

Furthermore, validation of the Be-in/Be-out (BIBO) status is accomplished by comparison of the first device movement consisting of speed, acceleration (x,y,z) with the vehicle movement consisting of speed, acceleration (x,y,z) broadcasted by the second device, to detect if the first device is actually in the same vehicle and not just e.g. driving next to it. Mismatches of the movement pattern will re-trigger evaluation to maintain the status Be-in/Be-out (BIBO). Such movement data can be acceleration data, rotational forces data, orientation data, gravity data, or a combination thereof. Correspondingly, the motion sensor of the mobile device can be an accelerometer, a rotational vector sensor, an orientation sensor, a gyroscope, or combinations thereof.

With such a system the checking-in of the client can also be (semi)automated such that convenience and accuracy of the method can be further increased. Such a system can be an assisted Check-in/assisted Check-out (ACIACO) system or an assisted Check-in/Be-out (ACIBO) system.

Term “check-in” occurs when the client accesses the vehicle, group of vehicles or an event.

The term “check-out” defines when a client exits the same vehicle, group of vehicles or leaves the event.

Term “vendor specific data” for data being transmitted by the second device. Such as but not limited to first device checked in, got a valid ticket, failed to check in, information about vendor.

Term “client” is used for a customer that would like to purchase for examples a ticket for transportation or to attend an event.

Term “client data” for data being transmitted by the first device. Such information as but not limited to, to the device checked-in: Monthly ticket, ticket coupon, senior pass.

The first and second device can establish a connection through any available network interface like, but not limited to, Wireless local area network (WLAN), Bluetooth network, ultra-wide-band network (UWB), a cellular network mobile phone adapter, and/or a local area network (LAN) adapter. The connection between the first device and second device via any of the pre-defined networks are established using customized and standardized protocols.

The issue of the desired ticket can have an individually incurred price. In this method, the issuing of the ticket may be achieved partially or completely by the client's device when it is recognized by the vendor or by the second device. This may be performed virtually, e.g., by only charging the calculated price to the passenger.

Achieving a fully optimized and convenient ticketing process by performing a fully automated check-in and check-out. The fully automated ticketing system also improves accessibility for e.g., visually impaired passengers which have limited access to ticketing operating machines and mobile applications.

Preferably, the second or a third device which can be stationary to check for valid ticket. In particular, the second/third device includes a radio module for wireless data transmission, where the second or third radio module is suitable and configured for exchanging data with the first device. Here, the second or third radio module is configured for sending an initialization or a broadcast which is received by the first radio module for initializing a wireless radio connection between the first device and the second and/or third device. The first device will transfer on request via the first radio module to the second or third radio module the current ticket(s) for validation.

### DESCRIPTION OF RELATED ART

Ticketing has developed over the years from a purely paper-based system into a variety of electronic and mobile ticketing schemes. To offer clients easy and ticketless Check-in/Check-out (CICO) possibilities, ticketless access systems have been created. These systems have the major drawback that they e.g., require user involved engagement to buy a ticket, or to check-in or check-out.

These systems work with GPS and/or on generic beacon systems. Beacon systems have the major drawback that these can easily be manipulated or duplicated and therefore are easily to deceive. Thus, there is a high potential of misuse by intercepting the location data provided by the client's app and manipulating the client's location.

There is also a high potential of the client forgetting to check in and therefore attending without a valid ticket. Furthermore, these systems require an internet connection to issue a valid ticket and therefore cannot offer a reliable service like in subways or in areas without cellular coverage or when saturated cellular networks prevent the clients from checking-in or getting a valid ticket.

Therefore, there is a need for a ticketing system allowing reliable identification of the usage of a transport system or attending an event, with or without an internet connection, without client interaction and based on, charging the client for using a transport system or attending an event.

### TECHNICAL FIELD

The disclosure relates to a system for the transmission of client data, for contactless and fully automated ticket purchases upon accessing a vehicle of a transport system, an event or service location.

Within the framework of e-commerce it is required to purchase a ticket to authorize access to an event or transportation system with devices that are unknown to each other. However, for fully automated authorization and purchase of tickets it is required to previously exchange client data, such as a user token or/and preferences and agreement on an object of purchase.

Within the system the possibility for the transmission of client data, in particular for acquiring tickets between two or more devices for contactless, fully automated ticket sales, without having a client interaction by means of confirming and/or initiating the communication between the unknown devices.

A Ticketing method comprising checking-in a client via their mobile device or wearable etc. upon accessing a transport system, checking-out the passenger via the mobile device upon exiting a vehicle of the transport system. Calculating a price for a clients travel within the transport system; based on the checking-in and check-out information determined by two or more unknown devices providing a fully automatic ticket service of the transport system to the passenger and charging them for using the transport system.

Within the system, devices can fully automate the opening of entry and/or exit barriers for devices unknown to each other without any user interaction or internet connection by transmitting the client data and/or ticket data.

Within the system, the second and/or third device can verify if a client has a valid ticket. This check is performed without the transmission of any personal data, is contactless without a need of client interaction and/or internet connection.

The issued ticket can easily be inspected by an inspector without the need to have the ticket presented in a conventional way like showing the ticket. The transmission of the ticket data is contactless to the authorized device (third device) of the inspector. Here the third device evaluates the validity and informs the inspector.

### BRIEF DESCRIPTION OF DRAWINGS

Hereunder the disclosure will be explained in detail on the basis of preferred embodiments with reference to the accompanying drawings in which:

FIG. 1 shows a schematic view of the system according to the invention,

FIG. 2 shows a flow chart of the method according to the invention, and

FIG. 3 shows an embodiment of a device according to the present invention.

### DETAILED DESCRIPTION OF THE DRAWINGS

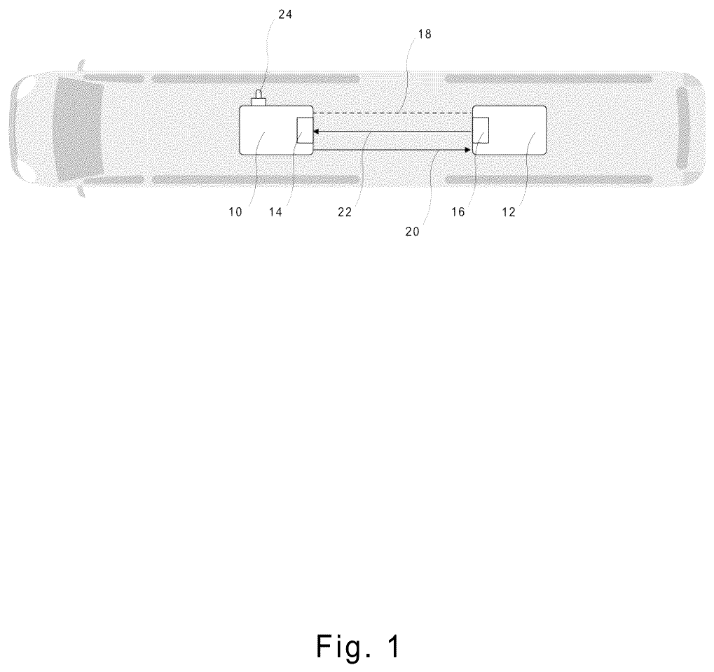

The system according to the invention shown in FIG. 1 includes a first device 10 as well as at least one second device 12. Here, the first device 10 includes a radio module 14 which is configured for wireless data transmission. Likewise, the second device 12 includes a second radio module 16 for wireless data transmission to the first device. Here, the wireless data transmission in particular includes both the transmission and the reception of client data.

For establishing a connection between the first device 10 and the second device 12 the first device 10 and/or the second device 12 first send an initialization 18 which is received by the respective other device 10, 12 for establishing a connection that is suitable for a wireless transmission of client or vendor data between the first device 10 and the second device 12. When the initialization has been performed, client or vendor data are then directly exchanged between the first device 10 and the second device 12. For example, for this purpose the first device 10 transmits client data to the second device 12 as shown by an arrow 20, which second device receives these client data. Alternatively, or additionally, vendor data of the second device 12 are transmitted to the first device 10 as shown by an arrow 22, which first device receives the vendor data. Then the client data and vendor data of the first device 10 and the second device 12 are further processed. If vendor data have been transmitted from the second device 12 to the first device 10, the processing is performed by the first device 10. If client data have been transmitted from the first device 10 to the second device 12, the processing is performed by the second device 12. Likewise, a processing of the client data can be performed by both the first device and the second device. If the processing shows that the predefined criteria has been satisfied, for example there is an adequate match of the required transportation request, a ticket is issued and an indication can be generated by means of an optically, acoustically and/or haptically indicating device 24 of the first device 10 and/or an optical, for example.

The client data are for example a purchase interest, an event specification, or a purchase price. Vendor data are for example pricing, availability, timing or a travel class.

In the illustrated example, the system includes only one second device. However, the invention is not limited thereto such that a plurality of second devices can be provided. If in the plurality of second devices the criteria is satisfied (where in all second devices the criteria can be the same or a different one and is predefined in an individualized manner), an indication is generated by all second devices. Alternatively, a selection on the basis of the degree of matching of the interests, a manual selection or a random selection is made.

Alternatively, for this purpose, necessary requirements can be checked for matching within the framework of the initialization such that in the case of lack of matching of these requirements no further connection between the first device and the second device is established and no further client data are transmitted.

If the criteria is satisfied and if in particular the respective client is a suitable vendor able to issue requested tickets, the indication device 24 generates an indication.

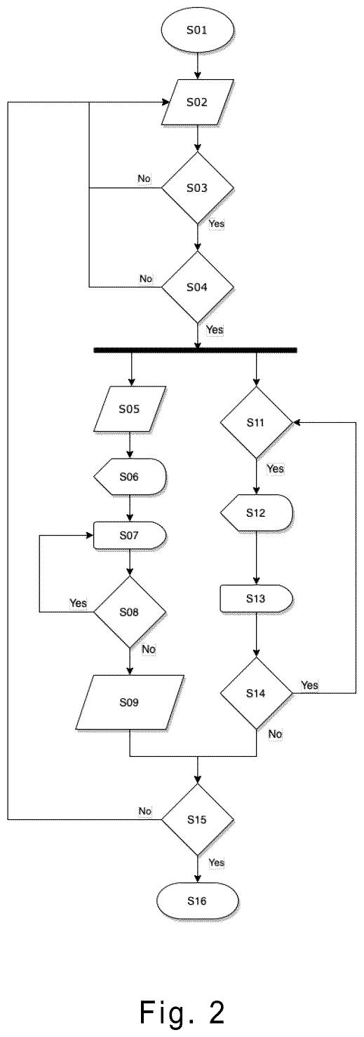

FIG. 2 shows the sequence of the method according to the disclosure. After the start S01 the first device 10 broadcasts an initialization 18 S02. Then it is checked whether the initialization has been received by another device S03. If the initialization has not been received by another device, another broadcasting of the initialization as per step S02 is performed at a later time. However, if the initialization has been received by another device and a connection is established between the first device 10 and the second device 12, the transmitted client's data and vendor's data are processed S04. If predefined criteria, such as a required match between the specified requirements, is not satisfied, the method is started again with broadcasting the initialization as per step S02.

However, if the predefined criteria are matching, a ticket is issued S05, and an indication is generated S06.

On the basis that a ticket has been issued, the devices will monitor if the devices are still connected, connectable or not checked out. Once the client device is checked out, the method is started again if the process is not canceled by the user S15.
S01 Start
S02 Initialization is broadcasted
S03 Initialization with another device successful?
S04 Predefined criteria satisfied?
S05 Issuing of a ticket (check-in)
S06 Generation of an indication
S07 Waiting for a predefined period of time
S08 Devices (vendor and/or client) still connected, connectable or not checked out?
S09 Finalize ticket sale (check-out)
S11 Message available
S12 Display Message
S13 Waiting for a predefined period of time
S14 Still checked in?
S15 Deactivated automated ticket purchase
S16 End

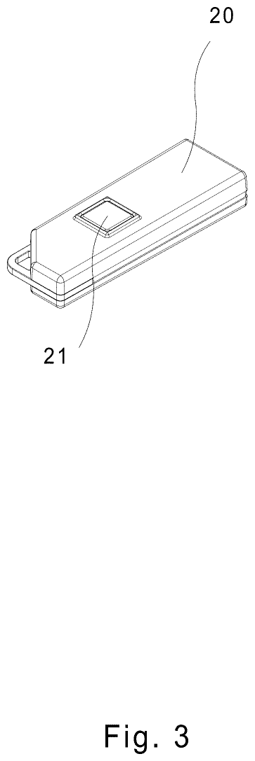

FIG. 3 shows an exemplary embodiment of a client's device according to the present invention configured as a wearable in the form of a key fob. Furthermore, the device 20 includes an operating element 21 for entering the information as to except or to reject a ticket, for example. Furthermore, the operating element is combined with an LED for generating an optical indication.

The system for the fully automated acquisition of tickets exchanges private data worthy of protection exclusively between the respective devices which have previously been initialized in a suitable manner. Thus, private client data for comparison between the respective client and vendor are not disclosed, and don't have to be transmitted via the internet or to a server, whereby the data integrity is increased, data misuse is prevented, and functionality is assured if no Internet is available. Sales data are only exchanged in an anonymized matter. In particular upon termination of the method, the respective vendor devices are designed to immediately delete the received client's data after completing the requested service such that reading from the respective device is not possible.

1. System for the fully automated acquisition of tickets, comprising: a first device having a first radio module for wireless data transmission, at least one second device having a second radio module for wireless data transmission and suitable for exchanging data with the first device, wherein the first radio module and/or the second radio module send an initialization which is received by the other radio module for initializing a connection between the first device and the second device, wherein, in the case of an initialized connection, the first device is configured for directly sending client data to the second radio module of the second device by means of the first radio module.

2. The system according to claim 1 wherein first device authenticates with second device (vendor). Following a successful authentication of the first device with the second device and vice versa. The second device (vendor) generates a virtual ticket. With the generated ticket, the client of the first device is granted access.

3. The system according to claim 1 where the client's user needs to confirm the log-in manually.

4. The system according to claim 2 where the client's user needs to confirm the log-in manually.

5. The system according to claim 1 wherein the second device (vendor) transfers the generated virtual ticket to the first device.

6. The system according to claim 1 wherein the first device (client) transfers messages and/or information to the second device (vendor).

7. The system according to claim 1 where the second device or first device can monitor and determine the client's presence. Therefor pricing can be dynamically calculated based on multiple and dynamic factors such as attendance time, peak hours, visited attractions/special vehicles taken, etc.

8. The system according to claim 1, further comprising more than one second device is provided, wherein the initialization is received and/or sent by all second devices.

9. The system according to claim 1, further comprising a third device is provided, wherein the third device comprises a third radio module for wireless data transmission, wherein the third radio module is configured for exchanging data with the second and/or the first device, wherein the first and/or the second radio module are configured for sending an initialization which is received by the third radio module for forwarding it to the radio module of the respective other device for initializing a wireless radio connection between the first device and the second device.

10. The system according to claim 1, wherein the personal data is not transferred to the second device via a base station, server, or a core network.

11. The system according to claim 1, wherein the first device sends the initialization by Broadcast.

12. The system according to claim 1, wherein the first device comprises a position module for determining the position of the first device and/or the second device comprises a position module for determining the position of the second device, wherein the first device and/or the second device are configured for exchanging their respective position either directly or over a common server, wherein the initialization between the first device and the second device is performed only when they are located at a predetermined distance to each other.

13. The system according to claim 1, wherein the first device and/or the second device comprise an optical and/or acoustical and/or haptic indication element for issuing the generated ticket.

14. The system according to claim 1, wherein the indication is in particular forwarded to a third terminal and in particular a separate indication device.

15. The system according to claim 1, wherein the first device and/or one of the second devices are a mobile terminal.

16. A method for operating a system according to claim 1.

17. A device for transmitting client data comprising a first radio module, wherein the first radio module is configured for sending or receiving an initialization such that a connection to at least one or a plurality of further device is established, wherein the first radio module is configured for receiving vendor specific data when the connection is initialized, wherein a processing of the received vendor specific data is performed and an indication is generated when a predefined criterion is satisfied.

18. A system according to claim 1, automatically calculates the price for a passenger's travel within the transportation system. This is accomplished through the second device, which evaluates the passenger's (representing) check-in data along with the passenger's (representing) check-out data.

19. A system according to claim 1, automatically calculates the price for a passenger's travel within the transportation system. This is accomplished through a common server, which evaluates the passenger's (representing) check-in data along with the passenger's (representing) check-out data.

20. The system according to claim 1 for the fully automated issuing of a ticket and charging a client for using a transport system or to attend an event by implemented hardware devices, the hardware device comprising:
client software executed on a mobile device (the first device) and at least one vendor (the second device) the ticketing method comprising checking-in the client via the first device upon the first device recognizing and detecting the second device (vendor) by informing the second device that first device is accessing, or has accessed, a first vehicle of the transport system;
client software executed on a mobile device (the first device) and at least one vendor (the second device) the ticketing method comprising checking-in the client via the second device upon the second device recognizing and detecting the first device (client mobile device) by informing the first device that first device is accessing (or has accessed) a first vehicle of the transport system;
client software executed on a mobile device (the first device) and at least one vendor (the second device) the ticketing method comprising checking-out the client via the first device if the previous checked-in to second device is out of range;
comprising client software executed on a mobile device (the first device) and at least one vendor (the second device) the ticketing method comprising checking-out the client via the second device if the previous checked-in to first device is out of range or does not respond within a given interval.

21. The system according to claim 1 validating the client's checked-in status by the first device comparing movement consisting of speed, acceleration with the second devices movement consisting speed, acceleration broadcasted by the second device.
